(19) United States
(12) Patent Application Publication
(10) Pub. No.: US 2013/0246383 A1
(43) Pub. Date: Sep. 19, 2013

(54) Cursor Activity Evaluation For Search Result Enhancement

(71) Applicants: Ryen William White, Woodinville, WA (US); Georg LW Buscher, Bellevue, WA (US); Susan T. Dumais, Kirkland, WA (US); Jeff Huang, Seattle, WA (US); Kuansan Wang, Bellevue, WA (US); Abdigani M. Diriye, London (GB)

(72) Inventors: Ryen William White, Woodinville, WA (US); Georg LW Buscher, Bellevue, WA (US); Susan T. Dumais, Kirkland, WA (US); Jeff Huang, Seattle, WA (US); Kuansan Wang, Bellevue, WA (US); Abdigani M. Diriye, London (GB)

(73) Assignee: MICROSOFT CORPORATION, Redmond, WA (US)

(21) Appl. No.: 13/423,243

(22) Filed: Mar. 18, 2012

(51) Int. Cl. G06F 17/30

(52) U.S. Cl. 707/706; 707/723; 707/E17.108

(57) ABSTRACT

The subject disclosure is directed towards using cursor activity with respect to search result pages to enhance search engine operation. Data associated with the cursor activity may be translated into cursor events representing user interactions with a search result page. Based on the cursor events, user behavior indicia may be identified via a user intent prediction model corresponding to various search result page related user actions. The user behavior indicia and/or the user intent prediction model may be used to produce search result pages for current search queries from the user.

### BACKGROUND

Currently, many people use search engines to complete various tasks throughout the day by submitting search queries and using a returned search result page to navigate a network to locate desired content. High user demand cause search engine providers to grow in size and capacity. The search engine providers, therefore, desire search engine improvement in order to provide desirable search result information that leads the user to more relevant and more useful electronic documents.

Gaze tracking has been employed in the past to capture richer insight into search user behavior when users examine search result pages. With gaze tracking, expensive devices (e.g., camera devices) may be needed to accurately record eye/head movement. These gaze tracking devices require regular maintenance and calibration. For these reasons, owning such a device is cost-prohibitive and, hence, scaling gaze data collection is impractical. Furthermore, aggregating the recorded eye/head movement with other eye/head movement data from other users may result in additional data storage capacity at one or more host servers. For the most part, conventional gaze tracking technology is restricted to tests under laboratory settings, which limits applicability of any collected gaze tracking data to predicting gaze position. A more efficient, affordable, scalable and less obtrusive process to model user behavior with respect to the search result pages is desired.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards evaluating cursor activity to enhance search results. In one aspect, after aggregating various cursor activity data from a population of user computers, an extraction mechanism may identify specific cursor events. Each specific cursor event may refer to a well-defined user action or sequence of user actions. In one aspect, the extraction mechanism may identify the cursor events by correlating cursor activities with logged user actions, which may be followed by building a prediction model for user interactions with respect to the search result pages.

In one aspect, the user intent prediction model may be deployed to a live search engine. The search engine may combine the user intent prediction model with an information retrieval model for ranking electronic documents based on search query relevance. By accounting for insights from the cursor activity, the information retrieval model may now be used to identify more relevant and useful search results in response to search queries. In one aspect, the information retrieval model may estimate click prediction rates for the electronic documents, which may be used by the search engine to automatically return a more accurate ranking for the search query. The user intent prediction model may also predict an upcoming abandonment of the search query for which the search engine may take action directed towards avoiding user abandonment.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram illustrating an example system for evaluating cursor data for search result page information according to one example implementation.

FIG. 2 is a functional block diagram illustrating an offline training process for a user intent prediction model according to one example implementation.

FIG. 3 is a functional block diagram illustrating an online process for applying a user intent prediction model according to one example implementation.

FIG. 4 is a flow diagram illustrating example steps for refining search result information using user behavior indicia according to one example implementation.

FIG. 5 is a block diagram representing example non-limiting networked environments in which various embodiments described herein can be implemented.

FIG. 6 is a block diagram representing an example non-limiting computing system or operating environment in which one or more aspects of various embodiments described herein can be implemented.

### DETAILED DESCRIPTION

Various aspects of the technology described herein are generally directed towards evaluating web page-related cursor data to improve search engine performance. In one example implementation, the cursor data may refer to various cursor activities associated with search engine users, including pointer clicks (e.g., a click-through), scrolling, text selection, cursor positions/movements and/or the like. The various cursor activities may be combined with logged data from the search engine such that each cursor activity maps to one or more logged events providing additional data. As an example, the cursor data may relate a pointer click with a corresponding query-click pair enabling the technology to identify a search query that led to the pointer click.

In one example implementation, an extraction mechanism may generate user behavior indicia for a particular cursor activity, or a lack thereof, by extracting features from the cursor data and comparing the feature data to user behavior categories (e.g., inactive, malicious activity (e.g., a bot), examining, reading, selecting and/or the like). A matching category may indicate user intent behind the particular cursor activity, which may refer to user action or inaction. An example user may peruse the search result page by scrolling, select a relevant search result reference with a pointer click or perform little or no cursor activity while paying attention to an area of interest. For instance, the example user may express interest by hovering over or around a search result. The user behavior categories may be further distilled into specific user groups and/or query groups. For example, the extraction mechanism may produce a user behavior profile from the cursor data and assign a user group and/or a query group having in same or similar behavior patterns. Therefore, the user intent behind the particular cursor activity may be specific to the assigned user group and/or query group.

The feature data from the cursor data may improve search result ranking mechanisms being employed by the search engine. Instead of (or in addition to) capturing insights regarding the order in which search results are clicked, the feature data may capture insights into search result-related user behaviors that do and do not lead to pointer clicks (e.g., which relevant documents received attention, a scan sequence ordering and/or the like). The feature data also may be used to cluster the search engine users and/or the search queries into user groups and/or query groups, respectively, to define differences between the search result-related user behaviors. The example user may be more likely to select one or more search result references if other users in the assigned user group also selected one or more search result references. The example user may be more likely to abandon a search query if the assigned query group includes search queries that are often abandoned. Hence, such feature data may identify and/or predict various user behavior associated with search result relevance, such as search query abandonment, click-through likelihood, a gaze position and/or the like, which may depend upon which the user group and/or query group assignment.

Using the feature data, the extraction mechanism may train/update various user intent prediction models, such as an abandonment model, a user and/or query cluster model, a relevance/click prediction model, a gaze prediction model and/or the like. These offline-trained models may be brought online and deployed to a live search engine for public and/or private use. Therefore, when a user submits a search query, the search engine can leverage user behavior (e.g., user action) predictions to initially provide a search result page and/or refine the search result page with a different ranking of documents, for example, and/or change other information (e.g., provide different suggested/related searches). If the cursor-related activity predicts that the user is about to abandon the search query and leave the search result page (e.g., for reasons associated with dissatisfaction), the search engine may rely on the user behavior predictions to modify the search result page in some way, such as to suggest different search query terms.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and search engine operation in general.

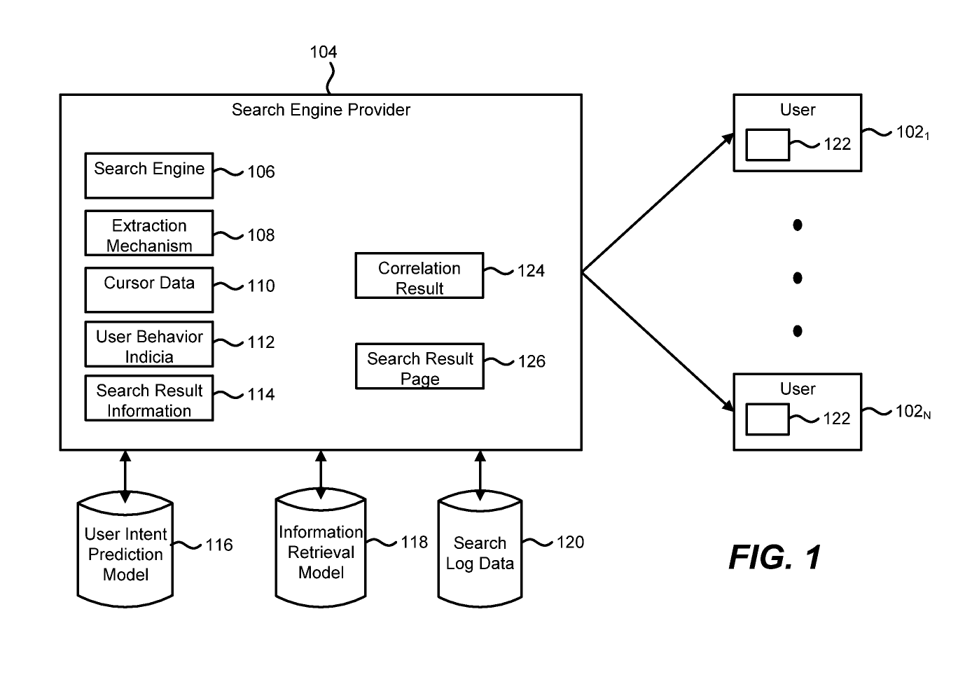

FIG. 1 is a block diagram illustrating an example system for evaluating cursor data for search result pages according to one example implementation. Components of the example system may include a plurality of user computers 102₁ . . . 102_{N} (hereinafter referred to as the users 102) and a search engine provider 104. The search engine provider 104 may include one or more computing platforms that deploy a search engine 106 for public and/or private use.

According to one example implementation, the search engine provider 104 may include an extraction mechanism 108, which may comprise various hardware and/or software computing components and/or any combination thereof configured to generate cursor data 110 using captured data communicated by the users 102. The cursor data 110 may generally refer to any data corresponding to user interactions with a browser component's rendered output including one or more search result pages. The user interactions may involve an input device (e.g., a pointer device, such as a mouse) on an example user computer and a display screen to present various cursor activities to the user.

The extraction mechanism 108 may execute various computing techniques to identify various cursor events of interest in the cursor data 110. Considering bandwidth and log size constraints, it may be more practical to extract a sampling of the cursor data 110 by classifying certain cursor activity as cursor-related events of interest and discard other data. For example, one such cursor-related event may include a pause in cursor movement in excess of a pre-determined threshold time period (e.g., a number of milliseconds (ms), such as forty (40) ms) and further indicate a user direction change. Another example cursor-related event may include cursor movement in excess of another set of pre-determined thresholds, such as cursor movement in excess of eight (8) pixels over two-hundred and fifty (250) milliseconds. Numerous other examples of cursor activity may be classified as cursor-related events of interest.

The extraction mechanism 108 may combine user behavior indicia 112 with search result information 114 into a user intent prediction model 116 for incorporating trained model data (e.g., feature/action weights, parameter estimates, training data and/or the like) into an information retrieval model 118 associated with the search engine 106. Using various searching system-related computing techniques, the extraction mechanism 108 may train the user intent prediction model 116 by interpreting the user behavior indicia 112 from one or more cursor-related events for a search result page and generating a user action prediction. When compared to actual user behavior with the search result page, which is captured in the search result information 114, the extraction mechanism 108 may learn feature weights/parameter estimates and adjust the user intent prediction model 116 accordingly. After aggregating a set of search result pages, the extraction mechanism 108 may further train the user intent prediction model 116 by computing weights for identifying various user actions from the cursor data 110 and/or clustering or grouping related users and/or queries based on the user behavior indicia 112.

As described herein, the extraction mechanism 108 may perform various offline and/or online processes for training and/or using different components of the user intent prediction model 116, such as a relevance prediction model, a search result page abandonment model and/or the like. In an example offline process, these prediction models may be trained with multiple search engine result pages (e.g., SERPs) and associated user interactions (e.g., via a cursor). In an example online process, these prediction models may be applied to a single search result page, although there may be instances where the prediction models may be applied to multiple search result pages (e.g., when aggregating user behavior within a search session or task).

Over a certain time period, the search engine provider 104 stores search log data 120 by aggregating information provided by browser agents 122 that are installed on the users 102. According to one example implementation, the browser agents 122 may include one or more JavaScript-based logging functions that may be embedded into hypertext source data for a search result page. The browser agents 122 may also include browser component modules (e.g., plug-ins) that enable additional capabilities when using the search result pages.

The logging functions may interpret user interactions with the search result page from which the extraction mechanism 108 may apply various techniques for generating the user behavior indicia 112. Within an example of the browser agents 122, the extraction mechanism 108 may instrument the embedded JavaScript code to process computational data stored by a user computer component, such as the browser component. Such computation data, for example, may indicate cursor events corresponding to the search result page's borders relative to a top-left corner.

Instead of recording the cursor data 110 at pre-set time intervals, such as every fifty milliseconds (50 ms) or every one-hundred milliseconds (100 ms), or only during periods of activity, the browser agents 122 may record such information after a movement delay. One example movement delay may refer to an amount of cursor inactivity time (e.g., forty milliseconds (40 ms)) that causes the extraction mechanism 108 to partition the cursor activity 110 and to generate new information corresponding to current and/or future cursor events. Each partition may include a set of related, recorded cursor events, such as direction changes in moving or at endpoints before and after a move, user hesitations while moving, pointer clicks and/or the like. The set of related recorded cursor events may be communicated to the search engine provider 104 at pre-determined time intervals (e.g., two seconds).

The extraction mechanism 108 may execute a technique for identifying an area of interest from recorded information corresponding to the cursor-related events, such as cursor movements, pointer clicks (e.g., a click-through), scrolling, text selection events, focus gain and/or loss events of the browser component of the example user computer, bounding boxes of certain areas of interest and a viewport size, and/or the like. The recorded information may also indicate various search result page characteristics, such as position coordinates for the areas of interest. By way of example, the areas of interest may be defined with cursor-related activity with respect to a portion (or contiguous group of portions) of the search result page, such a GUI control, an HTML element, an embedded link for a relevant document and/or an advertisement, a preview feature (e.g., a search engine function that renders a portion of the relevant document), a search query dialog box and/or the like.

After extracting various features using related portions of the search log data 120, the extraction mechanism 106 may define specific user actions based upon feature data. Each feature may be defined as a set of various cursor-related events, such as cursor trails, reading patterns, pointer clicks, scrolls, hover views, text selections (e.g., highlighting), search box interactions and/or the like over a pre-established time period. As an example, the extraction mechanism 108 may classify one or more features, into the specific user actions, such as a re-query (e.g., a search request for another search query), user attention (e.g., reading, gazing and/or the like), an electronic document selection and/or the like.

According to one example implementation, the extraction mechanism 106 may be configured to produce a correlation result 124 that stores the classifications between the feature data and the set of user actions. The extraction mechanism 106 may use the correlation result 124 to generate or update the user intent prediction model 116. The extraction mechanism 106 may deploy the user intent prediction model 116 such that the search engine 108 may compute and use a user action prediction for a current search result page being displayed to one of the users 102.

Once brought online, the updated information retrieval model 118 may be used by the search engine 106 to generate an initial or refined search result page 126 in response to a search query. By way of example, the search result page 126 may include a ranked list of relevant documents with a highest likelihood of being relevant (e.g., being selected/clicked) amongst search engine users of a user cluster having a same or similar set of the user behavior indicia 112, which may include gaze position predictions, and/or amongst search queries of a query cluster having same or similar query terms. Alternatively, the search engine 106 may respond to the search query by generating refined search queries, which may be formed by adding, removing and/or changing query terms to the search query based upon the user behavior indicia 112, and instructing the browser component to display the refined search queries on a corresponding portion of the search result page 126 (e.g., a hypertext object configured to display suggested search queries).

The search engine 106 may use the information retrieval model 120 to transform the user behavior indicia 112 and the search result information 114 into the refined search page 126. In one example implementation, the refined search result page 126 may include enhanced search results that convey additional information corresponding to each electronic document reference. An example enhanced search result may convey one or more user behaviors (e.g., positive or negative abandonment, dissatisfaction, re-query and/or the like), as expressed through cursor activities of a sample of the users 102 that visit the corresponding electronic document, in addition to a brief description and an embedded link. The search engine 106 may also generate a new ranking by reordering documents from a previous search result page, for example, in response to the user behavior indicia 112. According to another example implementation, the refined search result page 126 may include embedded links to potentially relevant documents from a more focused search.

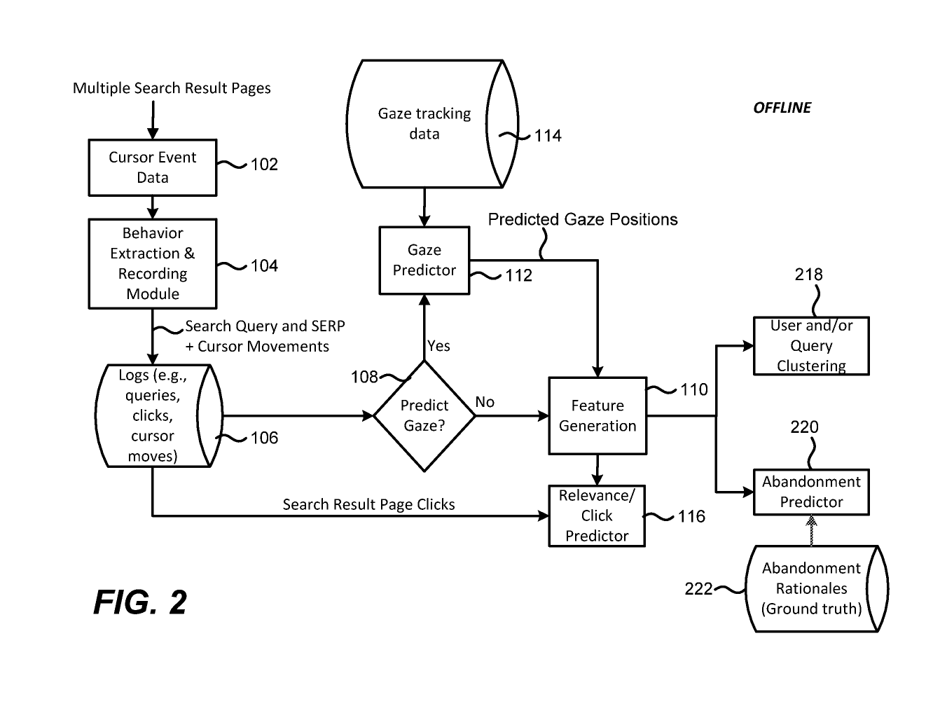

FIG. 2 is a functional block diagram illustrating an offline training process for a user intent prediction model according to one example implementation. Example components of the user intent prediction model may include a gaze prediction model, a user and/or query clustering model, an abandonment model, a relevance/click prediction model, as described herein.

While tracking cursor activity for multiple search result pages, an extraction mechanism (e.g., the extraction mechanism 108 of FIG. 1) may execute a process that is configured to record cursor event data 202 that represents interactions between user populations and the multiple search result pages. The cursor event data 202, such as cursor movements, clicks and/or the like, may be generated using a behavior extraction and recording module 204. Within logs 206, according to one example implementation, the behavior extraction and recording module 204 may map each portion of the cursor event data 202 to a corresponding group of one or more pairings between search result page and search query. For example, the behavior extraction and recording module 204 may generate query-click pairs that may be partitioned into search sessions or more specific search tasks.

A search engine provider (e.g., the search engine provider 104 of FIG. 1) may coordinate information communicated by a plurality of agents (e.g., the browser agents 122 of FIG. 1) being executed within web pages across a plurality of user computers. The search engine provider may configure the plurality of agents to collect various cursor data without user disruption. One example agent may execute a JavaScript function for logging cursor positions (e.g., mouse cursor position by periodically (e.g., every 250 milliseconds) capturing a cursor's y- and x-coordinates relative to an arbitrary position (e.g., a top-left corner) of the search result page). The example agent may also be configured to determine a width and height of the browser component viewport in pixels at search result page load time. Whenever the agent determines that a current cursor position changed by some threshold amount (e.g., more than eight (8) pixels) from a previous cursor position, coordinates for the current cursor position may be communicated to the extraction mechanism. In one example implementation, the example agent may capture the cursor alignment with the electronic document content regardless of how the cursor got to that position (e.g., by scrolling or through a keyboard entry).

Another example agent may record pointer clicks anywhere on the electronic document, for example, using the JavaScript “on MouseDown” event handling method and/or the like, to which the extraction mechanism may store as log entries comprising location coordinates for each pointer click, including pointer clicks on embedded links (e.g., hyperlinks), various content (e.g., an image) and white spaces containing no content that appears adjacent to or between markup data (e.g., web page) elements. In order to identify the pointer clicks on hyperlinks and differentiate these clicks from other pointer clicks on inactive elements, the extraction mechanism may store the location coordinates with embedded hyperlink identifiers (e.g., Uniform Resource Locators (URLs) or identifiers assigned to the embedded hyperlinks in the HTML source code for the web page). Certain inactive elements may be specifically identified, such as an image that causes numerous pointer clicks because it is thought to be a hyperlink by many users.

Another example agent may be configured to record a current scroll position, such as a y-coordinate of an uppermost visible pixel of the electronic document in a browser component viewport. As an example, such an agent may examine a pixel area associated with this y-coordinate a number of times (e.g., three (3) times) per second and if the y-coordinate changes by more a pre-defined number of pixels (e.g., forty (40) pixels) compared to a last scrolling position, the agent communicates a current scrolling position to the extraction mechanism. Forty pixels, for example, may correspond to a length of about two lines of text along the y-axis. After the extraction mechanism logs the last scrolling position and the current scrolling position, the extraction mechanism may determine which user action was performed, such a scroll up, a scroll down, a maximum allowed scroll length in the search result page, a scroll length and/or the like.

Yet another example agent may be configured to record searcher-selected text, such as highlighting, copy-and-pasting text to another application, or to issue a new query to the search engine. By executing browser component-specific JavaScript functionality, the example agent may identify text selections as well as bounding box of a corresponding web element (e.g., a markup language element), such as an immediately surrounding HTML element inside which the text selection occurred. For every text selection, the example agent communicates coordinate data associated with the bounding box, such as an upper left corner position, and/or a copy of the selected text.

By way of another example, another agent may define position and size data for one or more areas of interest to which the user devoted attention (e.g., as indicated by a gaze position prediction provided by the gaze prediction model). The extraction mechanism may examine the one or more areas of interest and a reconstruct the search result page layout as rendered. According to one example implementation, the areas of interest may include various markup language elements (e.g., objects, toolbars, scripts and/or the like) and/or graphical user interface (GUI) controls (e.g., dialog boxes), such as hyperlinks, top and bottom search boxes, a related search query list, a search history, a query refinement/suggestion area, a relevant document list, a rail for relevant advertisements and/or answers and/or the like. The area of interests may also indicate a document of interest within the relevant document list. For each area of interest bounding box, this agent may also communicate coordinates of an upper left corner as well as a width and a height in pixels. Using this information, the extraction mechanism may map cursor positions, clicks, and text selections to specific areas of interest.

After updating the logs 206, the extraction mechanism performs a determination 208 as to whether to predict user gaze position(s) in order to enhance raw data within the logs 206, such as the cursor event data 202 prior to initiating a feature generation module 210. In one example implementation, the extraction mechanism may proceed directly to extracting features from the logs 206. In another example implementation, the extraction mechanism may instruct a gaze predictor module 212 to generate more accurate cursor-related log data, which may benefit the feature generation module 210 when computing feature data.

If the extraction mechanism decides to improve the cursor-related activity within the logs 206 with gaze position predictions, the gaze predictor module 212 may be instructed to use gaze tracking data 214, comprising eye-tracking data, ground truth information, cursor movements and other data, to build/train the gaze prediction model. The gaze predictor module 212 may improve gaze estimation by correlating the cursor event data 202 with actual user attention on any search result page. In yet another example implementation, the extraction mechanism may use the gaze tracking data 214 to filter the cursor event data 202 and improve sampling of the cursor events during the offline training process.

The eye-tracking data may be captured using camera devices (e.g., web cameras attached to a computer), mapped to specific captured cursor events and used to train the gaze prediction model and enhance gaze position prediction accuracy. The gaze prediction model may indicate an alignment between cursor movements and eye gaze, which may denote a correlation between user attention and the cursor activity. For example, a user may move the cursor along with words being read, use the cursor to select or highlight interesting search result page documents, interact with graphical user interface controls (e.g., buttons, scroll bars) using the cursor. Alternatively, the user may re-position the cursor to avoid occlusions with rich Internet content.

The feature generation module 210 may employ various hardware and/or software modules to generate and analyze feature data by converting raw log data, such as the logs 206, into a set of features indicating various user behaviors, as described herein. As an example, in order to model the user behavior and cluster users and/or queries, the extraction mechanism generates a number of features based on movements, positions, pauses and dwells during cursor-related activity, which may be categorized as trails, hovers, result inspection patterns, reading patterns and/or the like, for example.

An example trail may be defined as one or more feature vectors that are derived from the cursor event data 202 and include trail length, trail speed, trail time, a total number of cursor movements, summary values (e.g., average, median, standard deviation) for single cursor movement distances and cursor dwell times in a same position, a total number of times that the cursor changed direction and/or the like. The example trail may include a contiguous sequence of cursor events, such as cursor movements and/or pointer clicks.

An example hover may be defined a combination of feature vectors that are derived from the cursor event data 202 and may include a total hover time, a hover time of the cursor over a particular element (e.g., a relevant document description and/or hyperlink or any other area of interest), idle time (e.g., a pause) and/or the like. The extraction mechanism may partition the total hover time into hover time portions, such as hover times on inline answers (e.g., stock quotes, news headlines and/or the like), in a search box, in a search support area (e.g., an area presenting related searches, query suggestions and/or search history), in an advertisement area, on relevant documents and/or the like.

An example result inspection pattern may be defined as one or more features that are derived from the cursor event data 202 and include a total number of search result pages over which the users hovered, an average search result page hover position, a fraction of a top ten results that were hovered, a search result page scan path and/or the like. The search result page scan path may comprise features associated with linearity of search result page scans. For example, the search result page scan path may be defined as a sequence of advertisements and/or relevant documents. A minimal scan sequence may be determined by removing repeat visits to a relevant document. The extraction mechanism may determine a likelihood that the scan sequence and the minimal scan sequence are linearly increasing indicating that users were traversing the search result pages linearly.

An example reading pattern may be defined as one or more features that are derived from the cursor event data 202 and include a frequency at which a cursor direction changes (e.g., left to right or right to left movements), vertical scrolling and/or other reading sequences that suggest search result page interactions. Furthermore, the example reading pattern may be combined with other data (e.g., keyword locations) to identify a portion of the search result page (e.g., an area of interest) to which the user likely paid attention.

The extraction mechanism may use the gaze predictor module 212 to estimate a current or future gaze position in relation to each cursor event. In one example implementation, the gaze predictor module 212 may evaluate one or more features and generate a gaze-cursor alignment between a gaze position prediction and a cursor position. The gaze predictor module 212 may identify each idle time as one example feature indicating various user behaviors, namely user activities during search result page load time, reading, scanning and/or the like. The idle time after the electronic document loaded, which may be known as a dwell feature, may influence the gaze-cursor alignment. Since the cursor position lags behind a current gaze position, there may be correlation between a later cursor position and the current gaze position. The later cursor position having a highest likelihood to match the current gaze position may be labeled a future feature. Furthermore, the gaze predictor module 212 may also use other time-related features associate with the user behavior to determine the current gaze position.

During the offline training process, the extraction mechanism may instruct a relevance/click predictor module 216 to build and/or update a relevance/click prediction model using query-click pairs from the logs 206 according to one example implementation. The relevance/click prediction model may be used to compute various hover-related features, such as a click-through rate (e.g., a percentage of URL-hyperlink click events out of instances when the search engine returned the URL in a search result page in response to a search query), a hover rate (e.g., a percentage of hovers associated with the URL-hyperlink out of the instances when the search engine returned the URL in the search result page), a number of unclicked hovers (e.g., a median number of hovers associated with the URL-hyperlink that was not clicked), a maximum hover time (e.g., a maximum amount of time that the user spent hovering over one or more related search result pages) and/or the like. When the example hover approaches the maximum hover time, the extraction mechanism may infer that the user is most likely interested in the search result page. The example hover may be used, instead of or in addition to the click-through rate, to estimate a relevance value/ranking for each URL returned in response to the query. When there are no pointer clicks on the search result page, the hover-related features provide a reasonable correlation with the relevance values. For example, as the number of unclicked hovers and/or the hover times increase, the relevance values may decrease for a particular electronic document reference or an advertisement.

The relevance/click predictor module 216 may search the logs and process a set of single search result pages, a set of aggregated search result pages or any combination thereof in order to extract cursor-related features. The set of single search result pages may include one-to-one mappings comprising one search result page for one search query. The set of aggregated search result pages may include one or more search queries for an information need (e.g., a task) and/or over a pre-defined time period (e.g., thirty (30) minutes).

Example relevance/click prediction features may include hover-related features, scroll-related features (e.g., a total number of scrolling events), click-related features and/or the like. An example hover-related feature may refer to an occurrence when the cursor moves within a particular area on the search result page, such as a particular embedded link to a relevant electronic document. The example hover-related feature may include a vector storing a set of cursor position coordinates, search result element(s) within the particular area, a time interval and/or the like. An example scroll-related feature may occur when the user scans the search result page, for example, until an embedded link for document returned for a query is no longer within a current view of the search result page, such as one full screen resolution cursor movement length. The example scroll-related feature may result from interactions with a scroll bar, scroll wheel, keyboard and/or the like. The extraction mechanism may use these example features to predict user action (e.g., a click on an embedded link, an abandonment and/or the like) in response to the search result page for the search query and/or a relevance of an electronic document and a search query.

The relevance/click predictor module 216 may update the information retrieval model by modifying and/or storing relevance related feature data between returned document links and the search query. The relevance/click predictor module 216, for example, may add or remove features and/or increase or decrease values (e.g., weights) for certain features, such as improving a positive abandonment weight with respect to relevance. The relevance related feature data also may include click-prediction rates, hover-related features and/or the like. The relevance/click predictor module 216 may produce a projected reordering of the electronic documents according to the relevance related features.

The cursor-related activity on web pages, comprising search result pages, electronic documents and/or the like, may be used to cluster users and/or queries having similar characteristics. A user and/or query clustering module 218 may define user and/or query groups or clusters based on common features associated with the user interactions, which may be extracted from historic cursor activity stored within the logs 206. For example, the user and/or query clustering module 218 may form a group for each number of users and/or queries that share similar search result page interaction behavior.

In one example implementation, the user and/or query clustering module 218 employs repeated-bisection clustering with a cosine similarity metric and classifies the users and/or queries into a specific behavior category according to the ratio of intra-cluster similarity to extra-cluster similarity. The user and/or query clustering module may use such a ratio to determine which user behavior category and/or which query-click behavior category to classify a specific user or query. An example query-click behavior category may refer to queries having same or similar cursor events and/or features. These queries may also share an information need and/or belong to a set of related information needs. Some of these queries may also correspond to a same task. Note that queries with search results corresponding with little or no cursor activity by a user may be improved by, for example, adjusting a ranking mechanism to identify more relevant electronic documents for future searches of the queries.

The user and/or query clustering module 218 may classify the users into user groups, such as one of three user groups: economic users, exhaustive-active users and/or exhaustive-passive users, in one example classification scheme. Economic users typically do not spend a significant amount of time exploring search result pages (relative to other user groups), initiate more directed cursor movements, and abandon search queries often. Economic users often have succinct, focused information needs, which may be satisfied by obtaining a tailored answer on the search result page or revisiting specific Internet resource (e.g., web sites). Exhaustive-active users typically explore search result pages in detail and ultimately tend to click on an embedded link to a relevant document. Exhaustive-passive users may explore the search result pages in a manner similar to the exhaustive-active users, but are less likely to click on a particular embedded link to a relevant document. The user and/or query clustering module 218 may use stereotypical behavior indicia for each user group as additional training data for the relevance/click prediction model in order to improve user behavior modeling in offline experimental settings.

An abandonment predictor module 220 may a build a model and identify rationale behind instances where a user fails to click any embedded links on a search result page resulting in an abandonment of a search query. Abandonment generally occurs when searchers visit the search result page but do not click on any URL-hyperlink, which may indicate various user behaviors, such as user dissatisfaction or user satisfaction (e.g., an answer found directly on the search result page). User inaction may also indicate other types of user behaviors, such as user disinterest and user interruption. When examining the entries in the logs 206 for abandoned search result pages, the abandonment predictor module 220 may learn abandonment related user behavior indicia utilizing various task-related features (e.g., features associated with an information need), such as cursor trail length (e.g., a total distance (in pixels) between two cursor positions on an electronic document), a movement time (e.g., a total amount of time (in seconds) associated with the cursor movement, a cursor speed (e.g., an average cursor speed (in pixels per second) as a function of trail length and movement time) and/or the like, according to one example implementation.

Because the logs 206 include a corresponding timestamp for each cursor event, the extraction mechanism may determine an amount of time for a user to first interact with an electronic document (e.g., a web page). An example agent may generate ground truth information 222 corresponding to the abandonment rationales by eliciting such explanations immediately after the user abandons the search query. The abandonment predictor module 220 may use the cursor event data 202 to distinguish between rationales behind search query abandonment. As an example, for certain search queries categories (e.g., weather information, stock prices and/or the like), answers are typically shown on the search result page and hence, there may be no need to click the URL-hyperlink or continue searching.

The abandonment predictor module 220 also may use other types of feature data to identify an appropriate abandonment rationale for a search query. One example of such feature data may be query-related feature data, which may involve task/session feature data, query-click pairs recorded before and after the search query, and/or the like. Of course, the query-click pairs recorded after the search query may be available when the abandonment predictor module 220 renders the abandonment rationale prediction at the end of the session rather than for a current search result page based on recently-monitored cursor activity. If a user clicks on a search result for a future query immediately following the search query, the user most likely abandoned the search query because of search result page dissatisfaction. The query-related data may include historic feature data mined from the logs 206, such as past click-through rates and query frequency. Another example of feature data may correspond to search result pages, for example, a number of search results, whether an answer is shown, a number of matching terms between the search query and title/snippets of each returned document, the search engine's ranking value for each returned document on the search result page and/or the like),

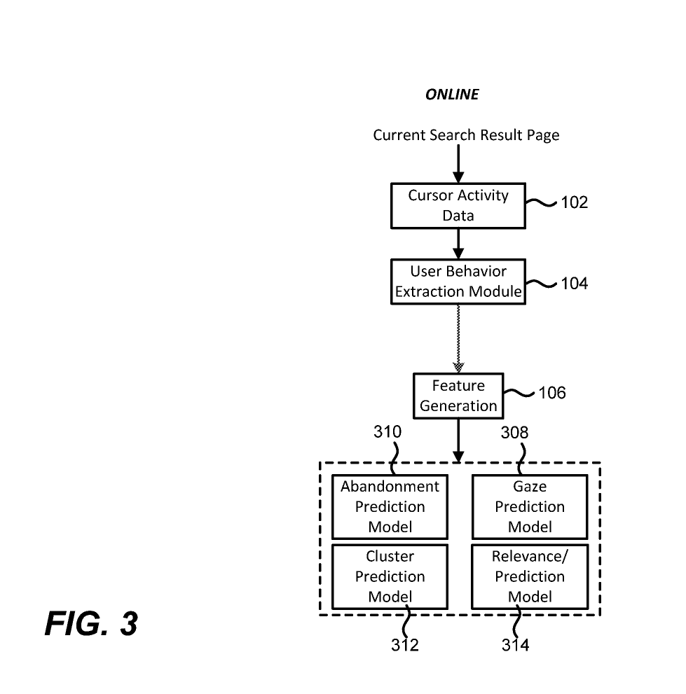

FIG. 3 is a functional block diagram illustrating an online process for applying a user intent prediction model to a current search result page according to one example implementation. A user may submit a search query, via a browser component running on a user computer, to a live search engine (e.g., the search engine 106 of FIG. 1) that responds with the current search result page comprising embedded links to relevant documents on the Internet. The browser component may render and display the current search result page in a form of one or more electronic documents on a computer display device. Through an input device coupled to the user computer, a user may interact with the one or more electronic documents by moving the pointer, which causes a cursor to move around a screen displayed by the computer display device, clicking the pointer to activate an embedded link, scrolling the current search result page to review relevant document descriptions and/or the like.

A search engine provider (e.g., the search engine provider 104 of FIG. 1) may enable Internet access to the live search engine. An extraction mechanism (e.g., the extraction mechanism 108 of FIG. 1) also running on the search engine provider may generate prediction model data for user behavior with search result pages, on behalf of the search engine and/or the browser component. The prediction model data may be deployed to the live search engine, which may incorporate the prediction model data into an information retrieval model.

In response to the search query, the live search engine may use the information retrieval model to rank electronic documents according to relevance and produce the current search result page. To illustrate one example of enhancing the information retrieval model, the prediction model data may be customized for a particular user group, which may further improve user satisfaction with likely more relevant search results for users of that group. In another example, the prediction model data may also be specific to one sub-group of the particular user group. One example sub-group may include one or more other users that share a user behavior profile associated with the user. In yet another example, the prediction model data may identify relevant search results for a particular query cluster that includes the search query.

When combined with the user intent prediction model data, the information retrieval model may be used to compute relevance related values between search queries and search result pages. One or more browser agents on the user computer may capture cursor activity data 302 corresponding to the user interactions with the current search result page and, such as cursor movements and pointer clicks, from which a user behavior extraction module 304 may extract cursor events representing user interactions with the current search result page. Other user interactions with the current search result page may also be captured using large-scale cursor tracking technology, including scrolling, text selections and/or the like.

The user behavior extraction module 304 may pass the cursor events to a feature generation module 306 to extract various features from the cursor activity data 302. The live search engine may compare the various extracted features to one or more prediction models, such as any combination of the following: a gaze prediction model 308, an abandonment prediction model 310, a cluster prediction model 312, a relevance prediction model 314 and/or the like. These prediction models have been trained offline (as described with respect to FIG. 2) to predict a user action given the cursor-related activity. In one alternative implementation, prior to supplying the cursor events to the feature generation module 306, the gaze prediction model 308 may also be used to supply more accurate cursor event data to the feature generation module 306. The user behavior extraction module 304 may combine the cursor activity data 302 with current and/or predicted gaze position and/or learn to extract various gaze-related features from a batch or aggregated set of search result pages.

The abandonment prediction model 310 may use the cursor activity data 302 to distinguish between different rationales behind search query abandonment by the users. Feature data generated from the cursor activity data 302 may be used to develop and/or refine the abandonment prediction model 310 for automatically predicting abandonment occurrence and/or rationale. User-confirmed rationales may also be used as a ground truth to train the abandonment prediction model 310. As an example, for certain search queries clusters/categorizes (e.g., weather information, stock prices and/or the like), answers are typically shown on the search result page and hence, there may be no need to click the URL-hyperlink or continue searching. In response to search queries for these search query clusters, the search engine may provide an enhanced search result page that includes rich descriptions (e.g., additional description content) for highly-ranked electronic documents. Other conditions may also prompt the search engine to expand the search results, such as a user behavior profile comprising average cursor-related activity for a likely search query cluster.

Using the cluster prediction model 312, the search engine may assign a user and/or query group to the user and/or the current search query. Based on the user group and/or the query group, the search engine may modify one or more portions of the current search result page to increase a likelihood that the user selects one or more search result references. For example, the search engine may more prominently render a suggested query portion if the user is dissatisfied with the current search result page. The search engine may refine or enhance the current search result page by providing richer answers or expanding document summaries, supporting repeat searches (e.g., re-queries) with a refined search query and/or the like. The search engine may refine or enhance the search result pages with richer document description summaries that may facilitate decisions regarding embedded link selection.

The search engine also may reorder (e.g., re-rank) the relevant documents using a same set or another set of search query terms, produce the search result pages according to different metadata (e.g., time/data ranges, topics, authors and/or other metadata) and/or the like. The search engine may refine or enhance the search result pages by expanding a relative document listing and/or providing diverse sets of relative documents, for example, to increase a likelihood that the exhaustive-passive users identifies relative documents that match information needs. Since the exhaustive-passive type users are more likely to submit a re-query relative to the other groups, the extraction mechanism may also support search query refinement by suggesting query terms to add, remove and/or modify.

In addition to supporting users directly, search engines also may use stereotypical behaviors for each user group as additional input to train the relevance/prediction models, which model searcher behaviors in offline experimental settings. Similarly, because cursor tracking provides evidence about the likely distribution of visual attention to elements on the search result page, it may be used to evaluate “good abandonment” (where no clicks on the search result page indicate satisfaction with the results), and/or to understand the influence of new features on the search result page.

As described herein, one application of the extraction mechanism is to estimate search result page relevance. The correlations between the cursor activity data 302 on search result page information and human relevance judgments (e.g., as denoted by clicks on search result pages) may be used to train search engine ranking technology and boost information retrieval performance. Based upon the cursor event data 202, the extraction mechanism may be trained to assign relevance labels on a rating scale to top-ranked search result pages for each search query, such as a binary scale or a five-point scale—“bad”, “fair”, “good”, “excellent” and “perfect”. Other feature data, such as click-through rates, hovers and/or the like, may be used to assign a relevance label for each URL returned in response to the search query. Even when there are no clicks for the search result page, the features may influence the relevance label assignments—for example, unclicked hovers and hover times may positively and/or negatively modify the relevance label assignments.

The relevance/prediction model 314 may correctly predict user actions, such as pointer clicks when the search result page corresponds to the user's information need. Embodiments or the relevance/prediction model 314 may include various models, such as a Dynamic Bayesian Network (DBN) based model, which makes the following assumptions about search result page examination behavior: (i) users go from top of the search result page to the bottom, (ii) whether a user activates an embedded link depends on usefulness, examination and/or relevance, (iii) whether the user continues examining afterwards depends on user satisfaction, and a click chain model, which assumes everything of the DBN model, but also assumes that (iv) users may also abandon, and (v) users may continue to search even when satisfied. The relevance/prediction model 314 may also incorporate features associated with cursor movement-related features and scroll events in order to increase user action prediction accuracy.

Optionally, the extraction mechanism, on behalf of the search engine, may use the cursor activity data 302 as usability feedback to monitor hover engagement with portions of the search result page when pointer clicks are not available or to monitor click engagement with features that do not include hyperlinks. The extraction mechanism may measure the hover engagement qualitatively, such as user intent, and/or quantitatively using features, such as a number of hovers or an amount of time spent hovering over a particular area. The cursor activity data 302 may include an aggregation of the cursor movements, which may be expressed as heatmaps or other visual representations depicting where user interactions occurred for different search result page features and/or queries. The heatmaps may illustrate aggregated user behavior across multiple query sessions or queries, which may be useful when determining whether users interact with new features and how user behavior changes following an introduction of the new features.

Another use of the cursor activity data 302 is in human/malicious activity detection. If the prediction models cannot determine user intent behind the cursor activity data 302 because the feature data does not match any trained feature data, malicious software may be operating within the user computer. Assuming that the cursor usually moves a negligible, trivial amount while scanning a web page, a set of web pages lacking cursor movement may be used for bot-traffic detection. “Bots” generally refer to web page crawlers that simulate related user behavior without moving the cursor. By measuring an active time duration referring to an amount of cursor activity time versus not inactive time duration, the search engine may indentify the crawlers if the inactive time duration exceeds the active time duration. Similarly, the cursor activity data 302 may also be used for more accurate query session/task segmentation by leveraging actual user behavior when examining the search result page.

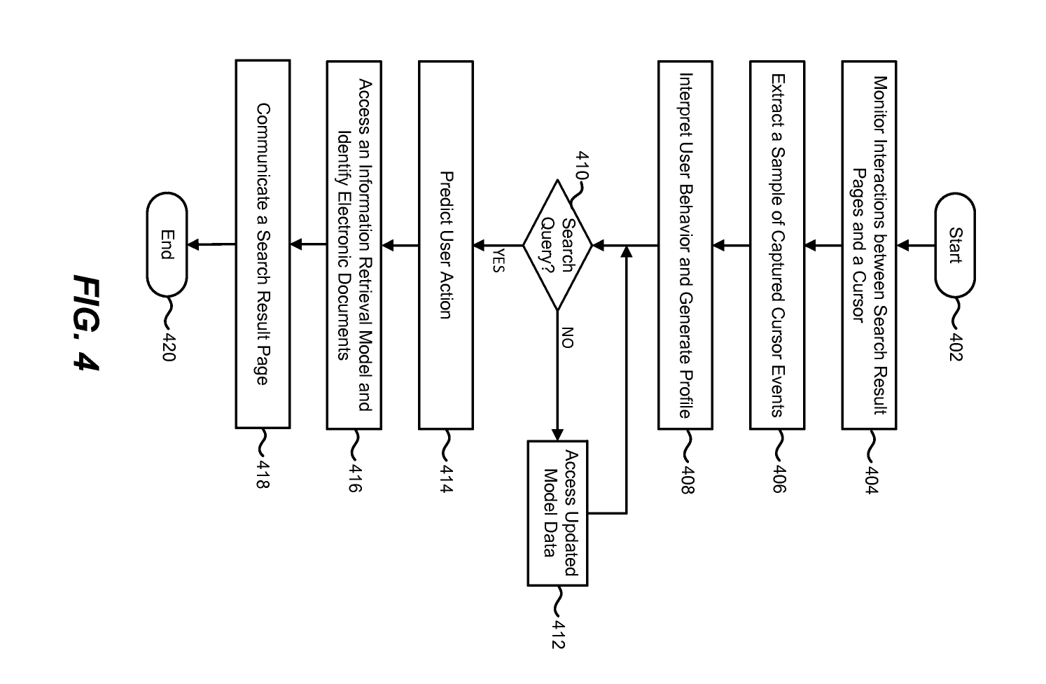

FIG. 4 is a flow diagram illustrating example steps for producing search result information using user behavior indicia according to one example implementation. One or more of the example steps may be performed by the search engine provider 104 of FIG. 1. The example steps commence at step 402 and proceed to step 404 at which interactions between a search result page and a pointer (e.g., an input device, such as a mouse, a keyboard and/or the like) are aggregated into cursor data (e.g., the cursor data 110 of FIG. 1). The search engine provider 104 may, in one example implementation, use one or more agents within a search result page being rendered and displayed on a user computer to monitor the user interactions with the search result page. The one or more agents may capture the cursor data associated with the search result page and/or communicate the captured cursor data to the search engine provider. Various components of the search engine provider, such as an extraction mechanism, may reduce the captured cursor data into a set of cursor events that, when compared with user intent prediction model data, may be used to identify cursor-related user behavior indicia as different combinations of feature vectors, as described herein.

Step 406 is directed to extracting a sample of the set of cursor events. In one example implementation, the extraction mechanism may delete cursor events that are not related to any user behavior category. The extraction mechanism may also retain cursor events that exceed a threshold level of user interaction. Examples of such cursor events include cursor movement in excess of a threshold number of pixels (e.g., eight pixels), a change in direction, and a pause in cursor activity in excess of a threshold time period (e.g., forty seconds). Step 408 refers to interpreting user behavior from the sample and generating a user behavior profile. In one example implementation, the extraction mechanism may covert the sample of cursor events into feature data for a set of features that represent the user behavior indicia during the cursor activity. The user behavior indicia may indicate one or more specific user actions, which may be a likelihood of user abandonment or a click prediction.

Step 410 determines whether the user communicated a search query to a live search engine within the search engine provider. If the user does not communicate the search query, step 410 proceeds to step 412. Step 412 refers to accessing updated model data from the user intent prediction models. For example, the extraction mechanism may periodically store new or modified feature weights into certain ones the user intent prediction models. After performing step 412, step 410 is repeated at which search engine provider determines whether there is a current search request. If the live search engine receives the search query, step 410 proceeds to step 414.

Step 414 also may predict a user action with respect to the search query based on the user behavior profile and/or the user intent prediction models. According to one example implementation, the user intent prediction model and/or a portion of the user intent prediction models may be used to compute a likelihood that the user clicks on at least one document reference of the potential search result page that may be provided in response to the search query. If the user behavior profile classifies the user as an exhaustive-active user, click prediction rates for document references and therefore, the pointer click likelihood for the potential search result page also may increase proportionally. Vice versa, the click prediction rates and the pointer click likelihood may decrease accordingly if the user is profiled as an economic user who may tend to select document references at a below-average probability.

The search engine provider also may compute a likelihood that the user abandons the potential search result page. The search engine provider may determine that the abandonment is likely to be classified negatively (e.g., a bad abandonment) if the potential search result page lacks relevant electronic documents and the user is predicted to not click on any embedded reference to an electronic document. A combination of the user intent prediction models and the user behavior profile, for example, may indicate a likelihood of various features, such as hover-related features and/or scroll-related features, being captured after the potential search result page is displayed to the user. If the user behavior profile is not available, the search engine provider may use the user intent prediction models to compute the likelihood of the various features being captured when an example user views the potential search result page.

As an alternative implementation, the search engine provider may predict that the abandonment is likely to be classified positively (e.g., a good abandonment) if certain features are present. For example, the user may abandon the potential search result page if an information need is satisfied with the information presented in electronic document summaries. Such an action may be identified using a set of related features including reading patterns associated with areas of interest over the electronic document summaries, a query group classification denoting that the document summaries are likely to satisfy the user's information need and/or the like. Some of these information needs may include topics (e.g., weather, stocks, traffic and/or the like) that involve a few lines of answer text. If a subsequent search of different query terms (sometimes referred to as a “re-query”) follows the predicted abandonment, the set of related features may further support a certainty as to the potential user satisfaction. If, for example, the document summaries satisfy the information need, the user is most likely to submit a new search query to satisfy another information need, rather than refining the current search query to satisfy the same information need.

Step 416 is directed to accessing an information retrieval model and identifying electronic documents for the search query. The information retrieval model may be built using various ranking mechanisms including one mechanism that incorporates at least one of the user intent prediction models when ranking the electronic documents for search queries. The live search engine may use the information retrieval model to produce a search result page comprising the electronic document ranking according to the predicted user action. As an example, the information retrieval model may identify a group of ten electronic documents having a highest likelihood of at least one pointer click by the user. Alternatively, numerous features, in addition to the likelihood of the at least one pointer click, may factor in determining whether the user is projected to click on an electronic document and be satisfied as to the electronic document's relevance to the search query.

If the user is likely to abandon the search result page because one or more top search results satisfied the user's information need, the live search engine may expand the relevant document summaries by including additional lines of text and/or using customized objects (e.g., a graphical user interface) for presenting the desired information in the document summaries. As an example, the live search engine may respond to a weather-related search query with a search result page that include a visual representation of current or projected outdoor weather as well as supporting data, such as temperature, precipitation, humidity and/or the like. As another example, the search result page may present a stock ticker graphic for displaying a desired stock price.

Step 418 refers to communicating the search result page to the user computer. In one example implementation, the live search engine may replace a previous or current ranking with the refined relevant document ranking in an initial search result page. The live search engine may also generate another search result page for displaying the refined relevant document ranking. According to another alternative implementation, the user intent prediction models may not be used to rank electronic documents with respect to the search query. Hence, the information retrieval model may provide a set of search results that do not account for cursor activity, but other areas of a search engine experiences may be enhanced and/or modified according to the user intent prediction models. For example, the live search engine may present suggested search queries more prominently (e.g., bigger text size, bigger element size and/or the like) on the search result page if user dissatisfaction is detected. Step 420 terminates the example steps depicted in FIG. 4.

### Example Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

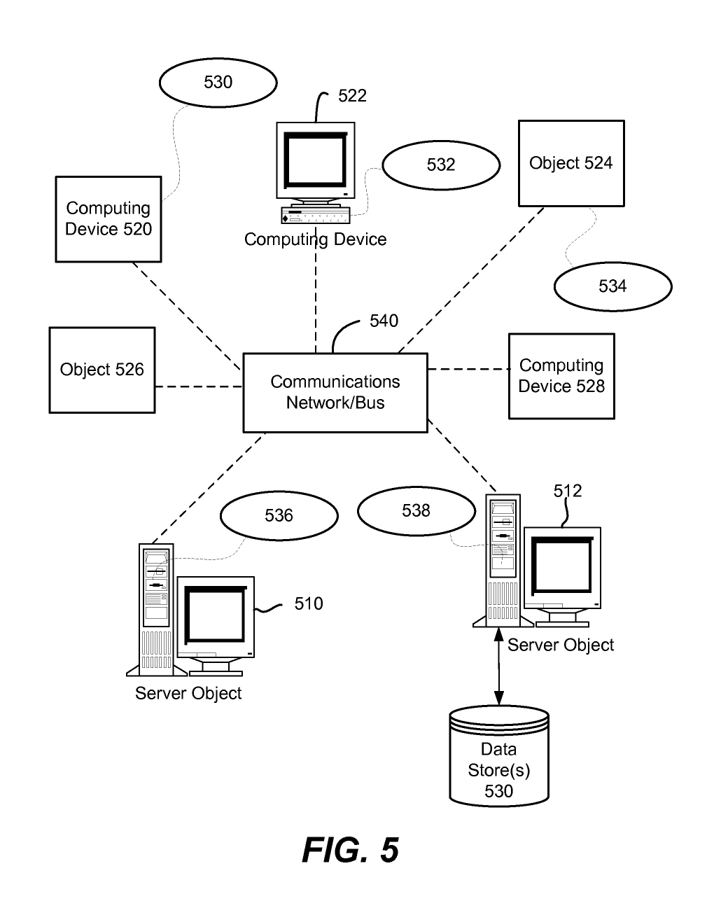

FIG. 5 provides a schematic diagram of an example networked or distributed computing environment. The distributed computing environment comprises computing objects 510, 512, etc., and computing objects or devices 520, 522, 524, 526, 528, etc., which may include programs, methods, data stores, programmable logic, etc. as represented by example applications 530, 532, 534, 536, 538. It can be appreciated that computing objects 510, 512, etc. and computing objects or devices 520, 522, 524, 526, 528, etc. may comprise different devices, such as personal digital assistants (PDAs), audio/video devices, mobile phones, MP3 players, personal computers, laptops, etc.

Each computing object 510, 512, etc. and computing objects or devices 520, 522, 524, 526, 528, etc. can communicate with one or more other computing objects 510, 512, etc. and computing objects or devices 520, 522, 524, 526, 528, etc. by way of the communications network 540, either directly or indirectly. Even though illustrated as a single element in FIG. 5, communications network 540 may comprise other computing objects and computing devices that provide services to the system of FIG. 5, and/or may represent multiple interconnected networks, which are not shown. Each computing object 510, 512, etc. or computing object or device 520, 522, 524, 526, 528, etc. can also contain an application, such as applications 530, 532, 534, 536, 538, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for example communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 5, as a non-limiting example, computing objects or devices 520, 522, 524, 526, 528, etc. can be thought of as clients and computing objects 510, 512, etc. can be thought of as servers where computing objects 510, 512, etc., acting as servers provide data services, such as receiving data from client computing objects or devices 520, 522, 524, 526, 528, etc., storing of data, processing of data, transmitting data to client computing objects or devices 520, 522, 524, 526, 528, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 540 or bus is the Internet, for example, the computing objects 510, 512, etc. can be Web servers with which other computing objects or devices 520, 522, 524, 526, 528, etc. communicate via any of a number of known protocols, such as the hypertext transfer protocol (HTTP). Computing objects 510, 512, etc. acting as servers may also serve as clients, e.g., computing objects or devices 520, 522, 524, 526, 528, etc., as may be characteristic of a distributed computing environment.

### Example Computing Device

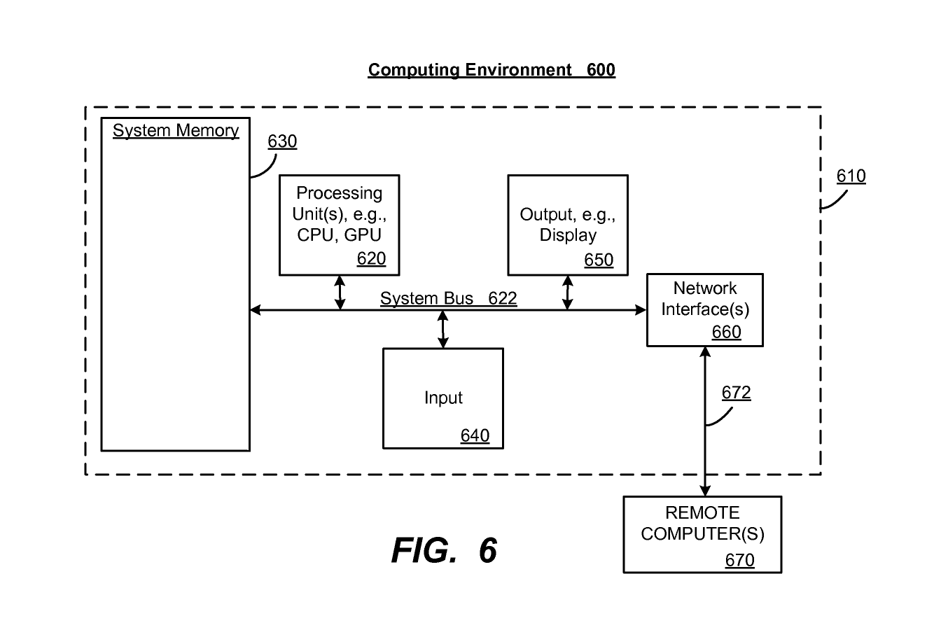

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 6 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 6 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. In addition, the computing system environment 600 is not intended to be interpreted as having any dependency relating to any one or combination of components illustrated in the example computing system environment 600.

With reference to FIG. 6, an example remote device for implementing one or more embodiments includes a general purpose computing device in the form of a computer 610. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640. A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 670. The remote computer 670 may be a personal computer, a server, a router, a network PC, a peer device or other common network node, or any other remote media consumption or transmission device, and may include any or all of the elements described above relative to the computer 610. The logical connections depicted in FIG. 6 include a network 672, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, using cursor data to improve search engine performance, including, processing the cursor data associated with web pages being presented to a user, extracting cursor events from the cursor data, identifying user behavior indicia from the cursor events based upon a user intent prediction model, and when the user submits a search query, producing a search result page using the user behavior indicia.

2. The method of claim 1 further comprising detecting a lack of cursor movement on a set of web pages indicating bot-traffic.

3. The method of claim 1 further comprising reordering relevant document links on the search result page based on the user intent prediction model.

4. The method of claim 1, wherein identifying the user behavior indicia further comprises generating feature data from the cursor data and search logs.

5. The method of claim 4, wherein generating the feature data further comprises identifying at least one of user groups and query groups according to the feature data.

6. The method of claim 4, wherein generating the feature data further comprises comparing the feature data with the user intent prediction model to assign a query group to the search query.

7. The method of claim 4, wherein generating the feature data further comprises comparing the feature data with the user intent prediction model to assign a user group to the user.

8. The method of claim 4, wherein generating the feature data further comprises identifying one or more areas of interest on the search result page based upon the cursor events.

9. The method of claim 1, wherein producing the search result page further comprises combining the user intent prediction model with the information retrieval model and transforming the information retrieval model and the user behavior indicia into the search result page.

10. The method of claim 1 further comprising producing a refined search result page using the user intent prediction model.

11. In a computing environment, a system, comprising, an extraction mechanism configured to generate a user intent prediction model for providing search results, wherein the extraction mechanism is further configured to identify a set of cursor events representing user interactions with search result pages, to generate feature data based on the set of cursor events, to produce a correlation result between user actions and the feature data, to update the user intent prediction model with the correlation result, and to incorporate the user intent prediction model into a search engine information retrieval model.

12. The system of claim 11, wherein the extraction mechanism is further configured to identify one or more abandonments of search result pages using the feature data and to build an abandonment model with the one or more abandonments.

13. The system of claim 11, wherein the extraction mechanism is further configured to process relevance values for one or more search result pages and to build a relevance model with the relevance values and a user action associated with each search result page.

14. The system of claim 11, wherein the extraction mechanism is further configured to process click-prediction rates for relevant electronic documents in each search result page and build a click-prediction model with the click-prediction rates and corresponding cursor activity.

15. The system of claim 11, wherein the extraction mechanism is further configured to access gaze tracking data for each search result page and build a gaze prediction model with the gaze tracking data and corresponding cursor activity.

16. The method of claim 1 further comprising training the user intent prediction model with the user behavior indicia and deploying the user intent prediction model in an information retrieval model.

17. One or more computer-readable media having computer-executable instructions stored thereon, which in response to execution by a computer, cause the computer to perform steps comprising:
monitoring a user computer to capture cursor activity associated with web pages;
examining a user intent prediction model to interpret a user behavior profile comprising feature data corresponding to the cursor activity;
determining a user action prediction for a current search query based on the user behavior profile; and
producing a search result page for ranking electronic documents according to a likelihood of at least one pointer click by the user.

18. The one or more computer-readable media of claim 17 having further computer-executable instructions, which in response to execution by the computer, cause the computer to perform further steps comprising:
accessing the information retrieval model if the user action prediction indicates an abandonment;
classifying the abandonment according to user rationale; and
if the abandonment is predicted to be negative, modifying one or more portions of the search result page in response to the user intent prediction model.

19. The one or more computer-readable media of claim 18 having further computer-executable instructions, which in response to execution by the computer, cause the computer to perform further steps comprising:
enhancing search results with expanded document summaries when producing the search result page.

20. The one or more computer-readable media of claim 17 having further computer-executable instructions, which in response to execution by the computer, cause the computer to perform further steps comprising:
identifying one or more areas of interest on the search result page;
generating another search result page based on the one or more areas of interest and an information retrieval model.
